(19) United States
(12) Patent Application Publication
(10) Pub. No.: US 2009/0080750 A1
(43) Pub. Date: Mar. 26, 2009

(54) PASSIVE MR VISUALISATION OF INTERVENTIONAL INSTRUMENTS

(75) Inventors: Sascha Krueger, Hamburg (DE); Steffen Weiss, Hamburg (DE); Hannes Dahnke, Hamburg (DE); Tobias Richard Schaeffter, London (GB)

Correspondence Address: PHILIPS INTELLECTUAL PROPERTY & STANDARDS, 595 MINER ROAD, CLEVELAND, OH, 44143, US

(73) Assignee: KONINKLIJKE PHILIPS ELECTRONICS N. V., Eindhoven (NL)

(21) Appl. No.: 12/297,649

(22) PCT Filed: Apr. 17, 2007
(86) PCT No.: PCT/IB07/51376

§ 371 Date: Oct. 20, 2008

(30) Foreign Application Priority Data
Apr. 21, 2006 (EP) 06112868.2
Nov. 3, 2006 (EP) 06123412.6

(51) Int. Cl. G06K 9/00

(52) U.S. Cl. 382/131

(57) ABSTRACT

The invention relates to a device for magnetic resonance imaging of a body (7), wherein the device (1) is arranged to a) generate a series of MR echo signals (20) by subjecting at least a portion of the body (7) to an MR imaging sequence comprising RF pulses and switched magnetic field gradients, b) acquire the MR echo signals for reconstructing an MR image (21) therefrom, c) calculate a susceptibility gradient map (22) from the MR echo signals or from the MR image (21), the susceptibility gradient map (22) indicating local susceptibility induced magnetic field gradients, d) determine the position of an interventional instrument (16) having paramagnetic or ferromagnetic properties from the susceptibility gradient map (22).

### FIELD OF THE INVENTION

The invention relates to a device for magnetic resonance (MR) imaging of a body placed in an examination volume.

Furthermore, the invention relates to an interventional instrument for MR guided interventional procedures and to a method for MR imaging as well as to a computer program for an MR device.

### BACKGROUND OF THE INVENTION

In magnetic resonance imaging pulse sequences consisting of RF pulses and switched magnetic field gradients are applied to an object (a patient) placed in a homogeneous magnetic field within an examination volume of an MR device. In this way, phase encoded magnetic resonance signals are generated, which are scanned by means of RF receiving antennas in order to obtain information from the object and to reconstruct images thereof. Since its initial development, the number of clinically relevant fields of application of MR imaging has grown enormously. MR imaging can be applied to almost every part of the body, and it can be used to obtain information about a number of important functions of the human body. The pulse sequence, which is applied during an MR scan, plays a significant role in the determination of the characteristics of the reconstructed image, such as location and orientation in the object, dimensions, resolution, signal-to-noise ratio, contrast, sensitivity for movements, etcetera. An operator of an MRI device has to choose the appropriate sequence and has to adjust and optimize its parameters for the respective application.

In interventional and intraoperative MR imaging high-performance computing and novel therapeutic devices are combined. These techniques permit the execution of a wide range of interactive MR guided interventions and surgical procedures. A basic issue of interventional MR imaging is the visualization and localization of instruments and surgical devices. This can be done either using active techniques, e.g. by means of RF micro coils attached to the tip of an instrument, or passive localization techniques that rely on local magnetic susceptibility induced image artifacts.

The active localization approach allows the immediate determination of the instrument coordinates and therefore allows robust tracking of instruments. It further enables functionalities like, e.g., image slice tracking. A drawback of active localization is that it implies a safety issue due to the presence of electrically conductive cables which may act as RF antennas and which may lead to dangerous tissue heating.

An interventional instrument having a magnetic susceptibility that deviates from the surrounding creates local inhomogeneities of the main magnetic field Bo. The known passive localization techniques are based on the exploitation of this effect since the susceptibility induced field inhomogeneities cause artifacts in the reconstructed MR images. These artifacts can be located directly in the MR images to enable the determination of the position of the instrument. The image artifacts may be generated by applying small amounts of magnetic (preferably paramagnetic or ferromagnetic) material to the instrument to be localized. Due to the absence of cables, the passive localization techniques are MR safe and especially appealing due to their simplicity.

For passive localization, susceptibility contrast enhanced MR imaging is usually performed via T₂ or T₂* weighted sequences. With these sequences the contrast is created by signal losses at the site of a local magnetic field disturbance. In the images generated by these known techniques, dark image features that are due to local field inhomogeneities cannot be distinguished from features that are due to other effects leading to signal losses or intrinsically low signal areas. Because of this, most know passive localization techniques are not very robust or limited to certain applications.

Several concepts of converting the dark image contrast into a positive (bright) contrast have been proposed to overcome the afore described drawbacks of passive localization, most of them not without compromising the actual imaging procedure. For example, EP 1 471 362 A1 discloses an MR method that is based on a gradient echo (GE) imaging sequence. In accordance with this known technique a certain imbalance of switched magnetic field gradients or additional gradients are applied in order to generate an MR image showing positive (bright) contrast between background tissue and objects (such as interventional instruments and devices) producing local magnetic field inhomogeneities. A drawback of this known technique is that in order to obtain optimal positive image contrast, either prior knowledge about the strength of the susceptibility gradients is required, or at least an elaborate and time-consuming optimization procedure has to be performed. Another drawback of this known technique is that the standard morphological MR image contrast is compromised because the method is focused on optimizing the contrast for device conspicuity.

Therefore, it is readily appreciated that there is a need for an improved device and method for interventional MR imaging which enables the localization of an interventional instrument with positive (bright) susceptibility contrast. It is consequently an object of the invention to provide an MR device that enables robust localization without compromising the actual MR imaging.

### SUMMARY OF THE INVENTION

In accordance with the present invention, an MR device for magnetic resonance imaging of a body is disclosed, which device is arranged to

a) generate a series of MR echo signals by subjecting at least a portion of the body to an MR imaging sequence comprising RF pulses and switched magnetic field gradients,

b) acquire the MR echo signals for reconstructing an MR image therefrom,

c) calculate a susceptibility gradient map from the MR echo signals or from the MR image, the susceptibility gradient map indicating local susceptibility induced magnetic field gradients,

d) determine the position of an interventional instrument having paramagnetic or ferromagnetic properties from the susceptibility gradient map.

The MR device of the invention is arranged to acquire an MR image in steps a) and b) by means of a standard imaging sequence that is conventionally used for imaging of the anatomy of the examined body (e.g. a 3D gradient echo sequence). The acquired MR image thus contains the complete anatomical information. In addition, a susceptibility gradient map is calculated in step c) from the acquired data. The susceptibility gradient map forms a data set that is separate from the actual MR image. It contains spatially resolved information about the susceptibility induced magnetic field gradient strength. This information is used in step d) to determine the position of the interventional instrument.

In accordance with a preferred embodiment of the invention, the MR device may be arranged to calculate the susceptibility gradient map in step c) by computing echo shift parameters from subsets of the MR image. The echo shift parameters indicate shifts of the echo positions in k-space, wherein each subset comprises a number of spatially adjacent pixel or voxel values of the MR image. The basic idea is to use the information with regard to local field inhomogeneity that is contained in each subset of spatially adjacent pixels or voxels of the reconstructed MR image data set. The local susceptibility gradients act in addition to the switched magnetic field gradients during imaging. The local susceptibility gradients cause shifts of the echo signal maxima in k-space. In accordance with the invention, a local echo shift parameter is calculated from a corresponding subset of pixels or voxels. This echo shift parameter is indicative of a shift of the echo position in k-space, wherein this shift stems from the susceptibility gradients affecting the pixels or voxels of the respective subset. Thus, the local susceptibility gradient strength can be concluded from the echo shift parameter. It is straightforward to convert the susceptibility gradient map into a positive contrast image simply by assigning grey values to the echo shift parameters. The device of the invention enables the production of a positive susceptibility contrast image by mere post-processing of a conventional (2D or 3D) anatomical MR image data set. An optimal positive contrast image is obtained without the use of dedicated sequences and without additional optimization procedures. This is why the technique according to the invention can be applied to MR guided interventional procedures without restrictions. The MR device may be arranged to determine and visualize the position of the interventional instrument simply by displaying the positive contrast image as an overlay superimposed on the actual MR image. Alternatively, the susceptibility gradient map may be further processed to extract the image coordinates of the device. In the simplest case, this may be achieved by determination of the location of extrema (for example local maxima) of the susceptibility gradient map. Preferably, for this case, the interventional device may be equipped with one or few prominent susceptibility markers that do produce pronounced local maxima in the susceptibility gradient map. The coordinates of the interventional device may be used to adapt imaging parameters of the MR device. One example is to center the MR imaging slice or volume automatically at the position of the device for subsequent scanning.

Preferably, the device is further arranged in accordance with the invention to calculate the susceptibility gradient map by computing Fourier transformations over adjacent pixel or voxel values of each subset of the MR image in step c). The echo shift parameters can then be computed by determining the positions of the maxima of the Fourier components for each subset. The positions of the maxima of the Fourier components correspond to the respective echo positions in k-space. Independent one-dimensional Fourier transformations may be computed over the adjacent pixel or voxel values in each spatial direction of the MR image data set. On this basis, the susceptibility gradient map can be calculated by computing the strength and direction of the susceptibility gradient from the echo shift parameters in the different spatial directions. In this way, the local susceptibility gradient vectors are calculated. This allows for the analysis of the direction and of the distribution of anisotropy of the susceptibility gradient. In a practical embodiment of the invention, the susceptibility gradient map may be calculated at a reduced spatial resolution as compared to the spatial resolution of the MR image data set. For example, if the echo shift parameters are calculated from subsets of n adjacent pixels or voxels, the spatial resolution of the susceptibility gradient map may be calculated at an n-fold lower resolution than the MR image data set.

The invention not only relates to an MR device but also to an interventional instrument for MR guided medical interventions. According to the invention, the instrument comprises a body made of electrically insulating plastic material doped with paramagnetic or ferromagnetic particles. The instrument may be, e.g., a catheter, a guide wire, a biopsy needle, a minimal invasive surgical instrument or the like. Such an instrument is well suited to determine its position by means of the above described positive contrast technique. The body of the instrument may be made of fibre reinforced plastic material doped with iron particles. Because of their mechanical properties, so-called GRP materials (such as, e.g., glass fibres in epoxy matrix) turn out to be particularly well suited for the production of MR safe guide wires. The plastic matrix of the instrument can be doped with iron particles in order to create the desired paramagnetic or ferromagnetic effects. In accordance with a preferred embodiment of the interventional instrument of the invention its body may have a free lumen allowing the insertion of an exchangeable element having paramagnetic or ferromagnetic properties. The exchangeable element advantageously allows to modify the strength of the susceptibility effect during the interventional procedure. An optimized visualization of the position of the interventional device can be achieved in this way. The susceptibility-induced contrast is influenced by instrument orientation with respect to the main magnetic field, interfering phase effects due to adjacent flow, etc. The right level of contrast can be chosen any time during the intervention by simply inserting or removing the exchangeable element while the instrument itself remains in place. The exchangeable element may also be moved within the free lumen of the instrument during the intervention in order to facilitate the localization of the instrument on the basis of the corresponding changes in image contrast. The exchangeable element may be doped homogeneously with magnetic particles. As an alternative, it may carry distinct magnetic markers producing local susceptibility artifacts. In accordance with a further preferred embodiment, the body of the interventional instrument can be coated with a biocompatible layer. A thin PU (polyurethane) layer is well suited to provide a hydrophilic coating and to imitate the surface characteristics and overall handling of conventional interventional instruments. A flexible filament may be embedded in the body of the interventional instrument in order to avoid breakage. An integrated polyamide or polyethylene filament can be used for this purpose.

The invention further relates to a method for magnetic resonance imaging of at least a portion of a body placed in an examination volume of an MR device. The method comprises the following steps:

a) generating a series of MR echo signals by subjecting at least a portion of the body to an MR imaging sequence of RF pulses and switched magnetic field gradients,

b) acquiring the MR echo signals for reconstructing an MR image therefrom,

c) calculating a susceptibility gradient map from the MR echo signals or from the MR image, the susceptibility gradient map indicating local susceptibility induced magnetic field gradients,

d) determining the position of an interventional instrument having paramagnetic or ferromagnetic properties from the susceptibility gradient map.

A computer program adapted for carrying out the imaging procedure of the invention can advantageously be implemented on any common computer hardware, which is presently in clinical use for the control of magnetic resonance scanners. The computer program can be provided on suitable data carriers, such as CD-ROM or diskette. Alternatively, it can also be downloaded by a user from an Internet server.

### BRIEF DESCRIPTION OF THE DRAWINGS

The enclosed drawings disclose preferred embodiments of the present invention. It should be understood, however, that the drawings are designed for the purpose of illustration only and not as a definition of the limits of the invention. In the drawings

FIG. 1 shows an MR scanner according to the invention;

FIG. 2 shows a diagram illustrating the method of the invention;

FIG. 3 shows an interventional instrument according to the invention.

### DETAILED DESCRIPTION OF THE EMBODIMENTS

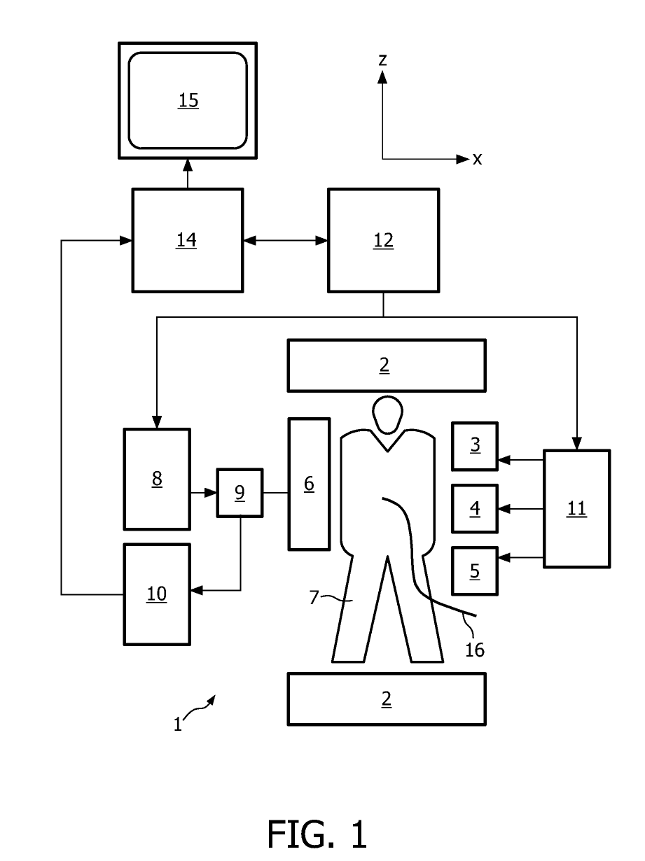

In FIG. 1 an MR imaging device 1 in accordance with the present invention is shown as a block diagram. The apparatus 1 comprises a set of main magnetic coils 2 for generating a stationary and homogeneous main magnetic field and three sets of gradient coils 3, 4 and 5 for superimposing additional magnetic fields with controllable strength and having a gradient in a selected direction. Conventionally, the direction of the main magnetic field is labeled the z-direction, the two directions perpendicular thereto the x- and y-directions. The gradient coils 3, 4 and 5 are energized via a power supply 11. The imaging device 1 further comprises an RF transmit antenna 6 for emitting radio frequency (RF) pulses to a body 7. The antenna 6 is coupled to a modulator 8 for generating and modulating the RF pulses. Also provided is a receiver for receiving the MR signals, the receiver can be identical to the transmit antenna 6 or be separate. If the transmit antenna 6 and receiver are physically the same antenna as shown in FIG. 1, a send-receive switch 9 is arranged to separate the received signals from the pulses to be emitted. The received MR signals are input to a demodulator 10. The send-receive switch 9, the modulator 8, and the power supply 11 for the gradient coils 3, 4 and 5 are controlled by a control system 12. Control system 12 controls the phases and amplitudes of the RF signals fed to the antenna 6. The control system 12 is usually a microcomputer with a memory and a program control. The demodulator 10 is coupled to reconstruction means 14, for example a computer, for transformation of the received signals into images that can be made visible, for example, on a visual display unit 15. As shown in FIG. 1, an interventional instrument 16, for example a guide wire for guidance of a catheter, is introduced into the body 7. The interventional instrument 16 has paramagnetic or ferromagnetic properties such that its susceptibility deviates from the surrounding tissue of the body 7. For the determination of the position of the interventional instrument 16 within the body 7, the MR device 1 comprises a programming for carrying out the above described passive localization technique.

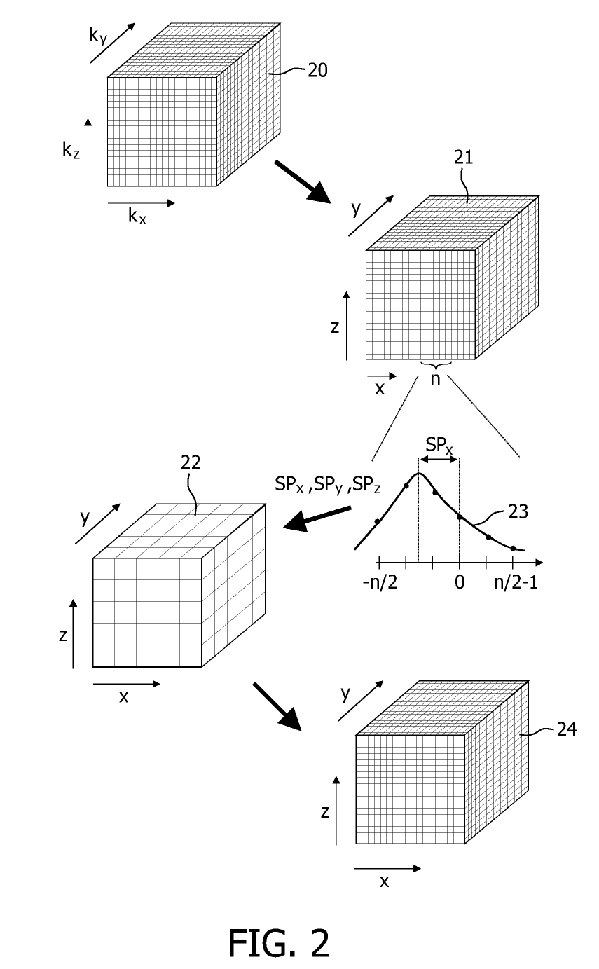

FIG. 2 illustrates the method of the invention as a diagram. In a first step, a 3D MR echo signal data set 20 is acquired by means of a conventional 3D gradient echo imaging sequence (for example 3D EPI). Then, the echo signal data set 20 is transformed into a (complex) 3D MR image 21 via standard image reconstruction techniques. As a next step, a three-dimensional susceptibility gradient map 22 is calculated. For this purpose, 1D Fourier transformations are performed for subsets of n adjacent voxels separately in all three dimensions x, y, and z. In FIG. 2, the determination of a single susceptibility gradient value in one spatial dimension is exemplarily shown. The 1D Fourier transform 23 comprises −n/2 to n/2−1 Fourier components. As can be seen in FIG. 2, the maximum of these Fourier components is shifted proportionally to the local susceptibility gradient acting in the direction of the Fourier transformation. From the discrete Fourier components 23, the position of the maximum is determined at sub Fourier component resolution by means of a least squares fitting procedure. The position of the maximum determines the echo shift parameter SPₓ for the respective subset of voxels. The same procedure is repeated for the determination of SP_{y} and SP_{z} in the remaining dimensions. The determination of the maxima separately for all three dimensions enables the composition of a vector representing the strength and direction of the susceptibility gradient for the respective subset of voxels. The magnitudes of these vectors determined for all subsets of n voxels constitute the susceptibility gradient map 22. The susceptibility gradient map 22 has an n-fold reduced spatial resolution as compared to the MR image data set 21. By linear interpolation and by assigning grey values to the susceptibility gradients 22, an image data set 24 with optimal positive contrast is generated. The image data set 24 can easily be adapted to weak and high susceptibility gradients via conventional image level and windowing operations. In this way, the susceptibility gradients induced by the interventional instrument 16 shown in FIG. 1 cause a positive contrast in image data set 24. For the visualization of the position of the instrument 16 single slices of the data set 24 can be displayed as an overlay superimposed on the corresponding slices of MR image data set 21 by means of the display unit 15, as shown in FIG. 1.

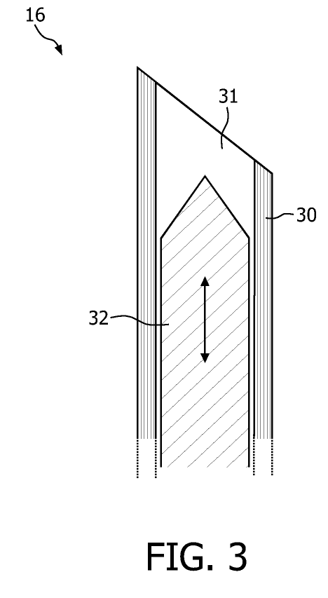

In FIG. 3, the tip of the interventional instrument 16 of the invention is shown in more detail. The instrument 16 is a guide wire for MR guided interventional procedures. The guide wire takes a key role for general guidance and navigation. The material of the body 30 of the guide wire is glass fibre reinforced plastic (GRP). From this material the guide wire is made using a so-called pulltrusion technology (pulltrusion means “pulled extrusion”). The GRP material holding the reinforcing fibres is doped with iron particles (diameter 1-6 μm) in order to create the magnetic susceptibility which is necessary to enable the passive localization of the instrument 16 as described above. Good mechanical properties are obtained by choosing a matrix to fibre ratio of 1:1 for the GRP material. The concentration of the iron particles may be about 10 μg/ml (iron/epoxy). This iron concentration does not significantly change the high electrical resistance of the material. Because of this, the guide wire can be said to be completely MR safe. A further advantage of the material of the guide wire is that it can be grinded. This allows, e.g., for a gradual thinning of the tip section of the guide wire which can be used to control the stiffness. A 10 μm polyurethane layer (not shown in FIG. 3) is applied to the surface of the guide wire to provide a hydrophilic coating and to imitate the surface characteristics and overall handling of regular guide wires. Furthermore, the coating prevents single broken reinforcing fibres from coming off the guide wire. As a mechanism to prevent total breakage of the guide wire, an additional flexible polyamide or polyethylene filament may be embedded in the matrix material of the instrument (not shown in FIG. 3). The body 30 of the guide wire has a free lumen 31 which allows the insertion of an exchangeable element having paramagnetic or ferromagnetic properties. In the depicted embodiment, the exchangeable element is an additional smaller wire 32. The diameter of the body 30 of the guide wire may be about 800 μm while the diameter of the smaller wire 32 may be about 300 μm. The thinner wire 32 may be doped homogeneously with magnetic particles or it may be provided with distinct magnetic markers producing the susceptibility effects required for passive localization in accordance with the invention. By insertion of the thinner wire 32 into the cladding 30 of the guide wire, the susceptibility effect can be modified during the interventional procedure and thereby adapted to obtain an optimal visualization. The thinner wire 32 is exchangeable at any time during the intervention while leaving the guide wire in place. Thus the surgeon can always choose the right level of contrast which may depend on the orientation of the instrument relative to the main magnetic field and eventually interfering phase effects from flow etc. Slight movements of the thinner wire 32, as indicated by the arrows in FIG. 3, may also improve the visual perception of the position of the guide wire in ambiguous situations.

1. A device for magnetic resonance imaging of a body, the device being arranged to
a) generate a series of MR echo signals by subjecting at least a portion of the body to an MR imaging sequence comprising RF pulses and switched magnetic field gradients,
b) acquire the MR echo signals for reconstructing an MR image therefrom,
c) calculate a susceptibility gradient map from the MR echo signals or from the MR image, the susceptibility gradient map indicating local susceptibility induced magnetic field gradients, wherein the susceptibility gradient map is calculated by computing echo shift parameters from subsets of the MR image, the echo shift parameters indicating shifts of the echo positions in k-space, wherein each subset comprises a number of spatially adjacent pixel or voxel values of the MR image,
d) determine the position of an interventional instrument having paramagnetic or ferromagnetic properties from the susceptibility gradient map.

2. (canceled)

3. The device of claim 1, wherein the device is arranged to calculate the susceptibility gradient map at a reduced spatial resolution as compared to the spatial resolution of the MR image.

4. The device of claim 1, wherein the device is further arranged to determine the position of the interventional instrument in the MR image by converting the susceptibility gradient map into a positive contrast image and by displaying the positive contrast image superimposed on the MR image.

5. The device of claim 1, wherein the device is further arranged to determine the position of the interventional instrument by establishing the coordinates of local extrema of the susceptibility gradient map.

6. The device of claim 1, wherein the device is arranged to adapt the parameters of the MR imaging sequence according to the position of the interventional instrument.

7. The device of claim 1, wherein the interventional instrument comprises a body made of electrically insulating plastic material doped with paramagnetic or ferromagnetic particles.

8. The device of claim 7, wherein the body is made of fibre reinforced plastic material.

9. The device of claim 7, wherein the body has a free lumen allowing the insertion of an exchangeable element having paramagnetic or ferromagnetic properties.

10. The device of claim 7, wherein the body is coated with a biocompatible layer.

11. The device of claim 7, wherein a flexible filament is embedded in the body of the instrument.

12. A method for MR imaging of at least a portion of a body placed in an examination volume of an MR device, the method comprising the following steps:
a) generating a series of MR echo signals by subjecting at least a portion of the body to an MR imaging sequence of RF pulses and switched magnetic field gradients,
b) acquiring the MR echo signals for reconstructing an MR image therefrom,
c) calculating a susceptibility gradient map from the MR echo signals or from the MR image, the susceptibility gradient map indicating local susceptibility induced magnetic field gradients, wherein the susceptibility gradient map is calculated by computing echo shift parameters from subsets of the MR image, the echo shift parameters indicating shifts of the echo positions in k-space, wherein each subset comprises a number of spatially adjacent pixel or voxel values of the MR image,
d) determining the position of an interventional instrument having paramagnetic or ferromagnetic properties from the susceptibility gradient map.

13. The method of claim 12, wherein the position of the interventional instrument is determined by converting the susceptibility gradient map into a positive contrast image and by displaying the positive contrast image superimposed on the MR image.

14. A computer program for an MR device, comprising instructions for:
a) generating an MR imaging pulse sequence,
b) acquiring MR echo signals for reconstructing an MR image therefrom,
c) calculating a susceptibility gradient map from the MR image, the susceptibility gradient map indicating local susceptibility induced magnetic field gradients, wherein the susceptibility gradient map is calculated by computing echo shift parameters from subsets of the MR image, the echo shift parameters indicating shifts of the echo positions in k-space, wherein each subset comprises a number of spatially adjacent pixel or voxel values of the MR image,
d) determining the position of an interventional instrument having paramagnetic or ferromagnetic properties from the susceptibility gradient map.

15. The computer program of claim 14, wherein the program further comprises instructions for converting the susceptibility gradient map into a positive contrast image, and for displaying the positive contrast image superimposed on the MR image.
